(19) United States
(12) Patent Application Publication
(10) Pub. No.: US 2025/0337051 A1
(43) Pub. Date: Oct. 30, 2025

(54) MULTI-LAYERED THERMAL BARRIER ASSEMBLIES FOR TRACTION BATTERY PACKS

(71) Applicant: FORD GLOBAL TECHNOLOGIES, LLC, Dearborn, MI (US)

(72) Inventors: Jie DENG, Novi, MI (US); Foo Chern TING, Canton, MI (US)

(21) Appl. No.: 18/648,841

(22) Filed: Apr. 29, 2024

(51) Int. Cl. H01M 10/658; F16L 59/02; H01M 10/613; H01M 10/625; H01M 10/6555; H01M 10/6557; H01M 50/211; H01M 50/242; H01M 50/249

(52) U.S. Cl. CPC H01M 10/658; F16L 59/029; H01M 10/613; H01M 10/625; H01M 10/6555; H01M 10/6557; H01M 50/211; H01M 50/242; H01M 50/249; H01M 2220/20

(57) ABSTRACT

Thermal barrier assemblies are provided for traction battery packs. An exemplary thermal barrier assembly may be configured to inhibit the transfer of thermal energy inside the traction battery pack. The thermal barrier assembly may include a first thermally insulating layer, a second thermally insulating layer, and an air gap extending between the first and second thermally insulating layers. The air gap may be established by integrated features provided at an interface between the first and second thermally insulating layers. The air gap may be configured to increase the thermal resistance across a thickness of the thermal barrier assembly, thereby reducing cell-to-cell and/or cell stack-to-cell stack heat transfer within the traction battery pack.

### TECHNICAL FIELD

This disclosure relates generally to traction battery packs, and more particularly to multi-layered thermal barrier assemblies for managing the transfer of thermal energy within traction battery packs.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A traction battery pack according to an exemplary aspect of the present disclosure includes, among other things, a cell stack including a first battery cell, a second battery cell, and a thermal barrier assembly arranged to limit heat transfer between the first battery cell and the second battery cell. The thermal barrier assembly includes a first thermally insulating layer, a second thermally insulating layer, and an air gap.

In a further non-limiting embodiment of the foregoing traction battery pack, the cell stack includes a cell expansion pad arranged between the first battery cell and a third battery cell.

In a further non-limiting embodiment of either of the foregoing traction battery packs, an inner face of each of the first thermally insulating layer and the second thermally insulating layer includes a roughened surface having a plurality of peaks and a plurality of valleys.

In a further non-limiting embodiment of any of the foregoing traction battery packs, the air gap extends between a first valley of the plurality of valleys of the first thermally insulating layer and a second valley of the plurality of valleys of the second thermally insulating layer.

In a further non-limiting embodiment of any of the foregoing traction battery packs, an inner face of each of the first thermally insulating layer and the second thermally insulating layer includes a raised surface.

In a further non-limiting embodiment of any of the foregoing traction battery packs, the raised surface extends vertically across a height of the thermal barrier assembly.

In a further non-limiting embodiment of any of the foregoing traction battery packs, the raised surface extends horizontally across a width W of the thermal barrier assembly.

In a further non-limiting embodiment of any of the foregoing traction battery packs, the air gap extends between adjacent sets of raised surfaces provided by the inner face of each of the first thermally insulating layer and the second thermally insulating layer.

In a further non-limiting embodiment of any of the foregoing traction battery packs, an inner face of each of the first thermally insulating layer and the second thermally insulating layer includes a dimple.

In a further non-limiting embodiment of any of the foregoing traction battery packs, the dimple of the first thermally insulating layer abuts the dimple of the second thermally insulating layer to establish the air gap.

In a further non-limiting embodiment of any of the foregoing traction battery packs, the cell stack includes a third battery cell, a fourth battery cell, and a second thermal barrier assembly arranged to limit heat transfer between the third battery cell and the fourth battery cell.

In a further non-limiting embodiment of any of the foregoing traction battery packs, the air gap establishes a fluid flow channel through an interior volume of the thermal barrier assembly.

In a further non-limiting embodiment of any of the foregoing traction battery packs, the thermal barrier assembly includes a first thickness, and the first thermally insulating layer includes a second thickness that is about ⅓ of the first thickness.

In a further non-limiting embodiment of any of the foregoing traction battery packs, the thermal barrier assembly includes a first thickness, and the air gap includes a second thickness that is about ⅓ of the first thickness.

In a further non-limiting embodiment of any of the foregoing traction battery packs, each of the first thermally insulating layer and the second thermally insulating layer is a mica sheet.

A traction battery pack according to another exemplary aspect of the present disclosure includes, among other things, a first battery cell, a second battery cell, and a thermal barrier assembly arranged between the first battery cell and the second battery cell. The thermal barrier assembly includes a first thermally insulating layer having a first integrated feature and a second thermally insulating layer having a second integrated feature. The first integrated feature and the second integrated feature cooperate to establish an air gap between the first thermally insulating layer and the second thermally insulating layer.

In a further non-limiting embodiment of the foregoing traction battery pack, the first integrated feature and the second integrated feature include roughened surfaces.

In a further non-limiting embodiment of either of the foregoing traction battery packs, the first integrated feature and the second integrated feature include raised surfaces.

In a further non-limiting embodiment of any of the foregoing traction battery packs, the first integrated feature and the second integrated feature include dimples.

In a further non-limiting embodiment of any of the foregoing traction battery packs, the first thermally insulating layer includes a first outer face that is received in abutting contact with the first battery cell and a first inner face that provides the first integrated feature. The second thermally insulating layer includes a second outer face that is received in abutting contact with the second battery cell and a second inner face that provides the second integrated feature.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 illustrates a traction battery pack of the electrified vehicle of FIG. 1.

FIG. 3 illustrates a cell stack of the traction battery pack of FIG. 2.

FIG. 4 is a blown-up view of select portions of the cell stack of FIG. 3.

FIG. 5 illustrates an exemplary thermal barrier assembly.

FIG. 6 is a blown-up view of select portions of the thermal barrier assembly of FIG. 5.

FIG. 7 is a cross-sectional view along line 7-7 of FIG. 6.

FIG. 8 illustrates another exemplary thermal barrier assembly.

FIG. 9 is a blown-up view of select portions of the thermal barrier assembly of FIG. 8.

FIG. 10 illustrates another exemplary thermal barrier assembly.

FIG. 11 is a blown-up view of select portions of the thermal barrier assembly of FIG. 10.

FIG. 12 illustrates yet another exemplary thermal barrier assembly.

FIG. 13 is a blown-up view of select portions of the thermal barrier assembly of FIG. 12.

### DETAILED DESCRIPTION

This disclosure details thermal barrier assemblies for traction battery packs. An exemplary thermal barrier assembly may be configured to inhibit the transfer of thermal energy inside the traction battery pack. The thermal barrier assembly may include a first thermally insulating layer, a second thermally insulating layer, and an air gap extending between the first and second thermally insulating layers. The air gap may be established by integrated features provided at an interface between the first and second thermally insulating layers. The air gap may be configured to increase the thermal resistance across a thickness of the thermal barrier assembly, thereby reducing cell-to-cell and/or cell stack-to-cell stack heat transfer within the traction battery pack. These and other features are discussed in greater detail in the following paragraphs of this detailed description.

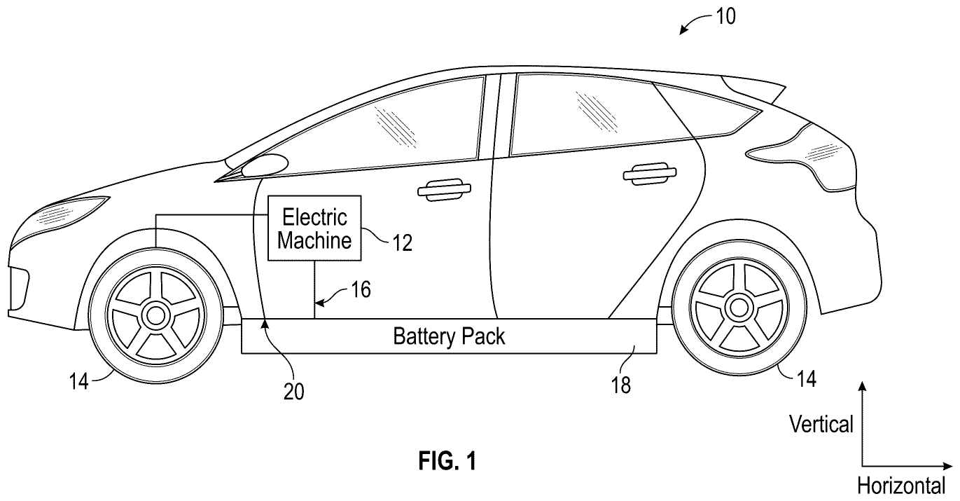

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In an embodiment, the electrified vehicle 10 is a full electric vehicle propelled solely through electric power, such as by one or more electric machines 12, without any assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cell groupings capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

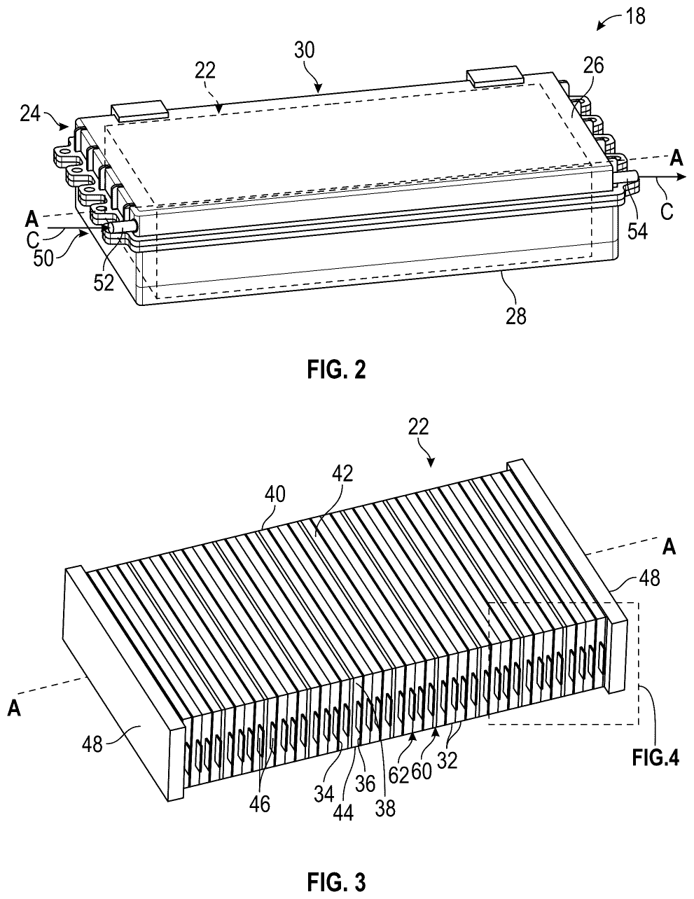

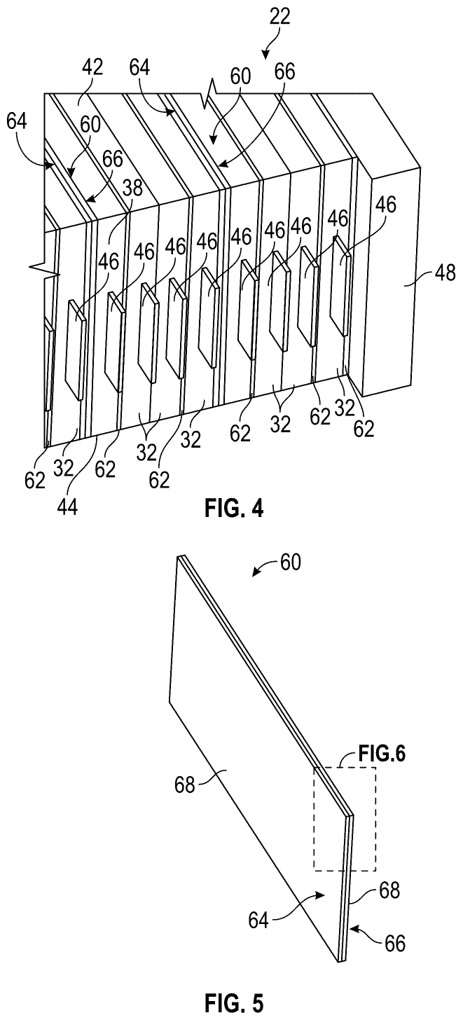

FIGS. 2, 3, and 4 illustrate additional details associated with the traction battery pack 18 of the electrified vehicle 10. The traction battery pack 18 may include one or more cell stacks 22 (e.g., one shown) housed within an interior area 30 of an enclosure assembly 24. The enclosure assembly 24 of the traction battery pack 18 may include an enclosure cover 26 and an enclosure tray 28. The enclosure cover 26 may be positioned vertically above the enclosure tray 28. However, the enclosure cover 26 could be arranged below or to a side of the enclosure tray 28. Various terms such as “above,” “below,” “top,” and “bottom” are used relative to the arrangement of the components of the traction battery pack 18 in the various drawings and should not otherwise be deemed limiting. These terms are with reference to the general orientation of the traction battery pack 18 when installed on the electrified vehicle 10 of FIG. 1. Vertical, for purposes of this disclosure, is also with reference to ground and how the traction battery pack 18 is oriented when installed on the electrified vehicle 10.

The enclosure cover 26 may be secured (e.g., bolted, welded, adhered, etc.) to the enclosure tray 28 to provide the interior area 30 for housing the cell stacks 22 and other battery internal components (e.g., busbars, control modules and other electronics, etc.) of the traction battery pack 18. The size, shape, and configuration of the enclosure assembly 24 may vary within the scope of this disclosure.

Each cell stack 22 may include a plurality of individual battery cells 32 that are arranged together along a cell stack axis A between opposing end plates 48. The battery cells 32 store and supply electrical power for powering various components in order to support electric propulsion of the electrified vehicle 10.

In an embodiment, the battery cells 32 are lithium-ion pouch cells. However, battery cells having other geometries (prismatic, cylindrical, etc.) and/or chemistries (nickel-metal hydride, lead-acid, etc.) could alternatively be utilized within the scope of this disclosure.

Although a specific number of cell stacks 22 and battery cells 32 are illustrated in the various figures of this disclosure, the traction battery pack 18 could include any number of the cell stacks 22, with each cell stack 22 having any number of individual battery cells 32.

Each battery cell 32 may include a first face 34, a second face 36 opposite the first face 34, a first end 38, a second end 40 opposite the first end 38, a top side 42, and a bottom side 44 opposite the top side 42. The first face 34 and the second face 36 establish major side surfaces of the battery cells 32, and the first end 38, the second end 40, the top side 42, and the bottom side 44 establish minor side surfaces of the battery cell 32. The first face 34 and the second face 36 therefore exhibit a greater surface area than any of the first end 38, the second end 40, the top side 42, and the bottom side 44.

A tab terminal 46 may project outwardly from each of the first end 38 and the second end 40 of the battery cells 32. The battery cells 32 may thus be considered to be “side-oriented” within the cell stacks 22. The tab terminals 46 may be connected to busbars (not shown) in order to electrically connect the battery cells 32 of each cell stack 22.

A cell expansion pad 62 may be arranged between some neighboring battery cells 32 within the cell stack 22. The cell expansion pads 62 may include a material(s) (e.g., polyurethane foam, silicone foam, etc.) adapted for accommodating battery cell swelling.

One or more thermal barrier assemblies 60 may be arranged along the respective cell stack axis A of each cell stack 22. In an embodiment, groups of four individual battery cells 32 are separated by thermal barrier assemblies 60 along the cell stack axis A. However, other configurations are contemplated within the scope of this disclosure, and it should be apparent those having the benefit of this disclosure that the cell stack 22 could include any number of and any arrangement of battery cells 32, thermal barrier assemblies 60, and cell expansion pads 62.

The battery cells 32 may be arranged such that the faces 34, 36 of one battery cell 32 are in direct contact with one of the faces 34 or 36 of a neighboring battery cell 32, of a neighboring thermal barrier assembly 60 of the cell stack 22, or of a neighboring cell expansion pad 62 of the cell stack 22. The battery cells 32, thermal barrier assemblies 60, and cell expansion pads 62 may be held in compression relative to one another within the cell stack 22 to provide the face-to-face arrangement. The compression may be applied by the end plates 48 of the cell stack 22, for example. However, other configurations are contemplated within the scope of this disclosure.

Thermal energy levels of the battery cells 32 of each cell stack 22 can increase as the electrified vehicle 10 is operated. A thermal management system 50 (see FIG. 2) can be employed for managing the thermal energy levels of the battery cells 32, cell stacks 22, and other areas of the traction battery pack 18. The thermal management system 50 may be configured to route a coolant C through the traction battery pack 18 in order to manage the thermal energy within the cell stack 22 by, for example, using the coolant C to take on heat from the cell stack 22.

In an embodiment, the thermal management system 50 is an immersion thermal management system in which portions of the traction battery pack 18, here at least portions of the battery cells 32, are immersed in the coolant C. Thermal energy can transfer between the coolant C and the battery cells 32 as the coolant C flows over and/or around the battery cells 32. The coolant C can help manage thermal energy levels of the battery cells 32 as well as other components of the traction battery pack 18.

The thermal management system 50 can deliver the coolant C to the interior area 30 of the traction battery pack 18 through an inlet 52. The coolant C can fill one or more open areas within the interior area 30 such that the battery cells 32 are immersed in, and directly contacted by, the coolant C within the traction battery pack 18. The coolant C can take on thermal energy from the battery cells 32 of the cell stacks 22 and other components of the traction battery pack 18 for managing the thermal energy levels. The coolant C may exit the traction battery pack 18 through an outlet 54, which may be located at an opposite end of the enclosure assembly 24 from the inlet 52. The coolant C exiting through the outlet 54 can move to a thermal energy exchange device (not shown), such as a heat exchanger, where thermal energy can be transferred from the coolant C to atmosphere. A pump (not shown) can be operated to selectively circulate the coolant C between the traction battery pack 18 and the thermal energy exchange device.

The coolant C circulated in the immersion thermal management system may be a dielectric fluid or another type of non-conductive fluid (e.g., oil) that is designed for immersion cooling the battery cells 32. However, other non-conductive fluids may also be suitable, and the actual chemical make-up and design characteristics (e.g., dielectric constant, maximum breakdown strength, boiling point, etc.) may vary depending on the environment the traction battery pack 18 is to be employed within.

In another embodiment, the thermal management system 50 is a conventional cold plate system in which the coolant C, such as glycol, is circulated through a cold plate (not shown) in order to thermally manage heat generated by the battery cells 32. The teachings of this disclosure are therefore not limited to immersion thermal management systems. The battery cells 32 are not immersed in the coolant C in this type of thermal management system.

The thermal barrier assemblies 60 may also function as part of the thermal management system 50. For example, the thermal barrier assemblies 60 may be arranged to limit the conductive cell-to-cell transfer of thermal energy across each cell stack 22 of the traction battery pack 18.

Referring now primarily to FIGS. 5, 6, and 7, each thermal barrier assembly 60 may be configured as a multi-layered structure that is configured to limit the conductive heat transfer of thermal energy across the cell stack 22. The multi-layered structure of each thermal barrier assembly 60 may include at least a first thermally insulating layer 64 and a second thermally insulating layer 66. Although two thermally insulating layers are shown in the exemplary embodiments, the thermal barrier assemblies described herein could include two or more thermally insulating layers within the scope of this disclosure.

The first and second thermally insulating layers 64, 66 may be made of one or more thermally resistant (and thus low thermal conductivity) materials such as mica, aerogel materials, refractory ceramic fibers, etc. However, other materials or combinations of materials could with utilized to provide the thermally resistant material of each of the first and second thermally insulating layers 64, 66.

The first thermally insulating layer 64 and the second thermally insulating layer 66 may each include an outer face 68 and an inner face 70 opposite the outer face 68. The outer face 68 may be positioned in direct contact with the first face 34 or the second face 36 of a neighboring battery cell 32 within the cell stack 22, and the inner face 70 may be positioned to interface with the inner face 70 of the other of the first thermally insulating layer 64 or the second thermally insulating layer 66.

As best illustrated in FIG. 7, each inner face 70 may include integrated features that cooperate with integrated features of the inner face 70 of the adjacent thermally insulating layer for establishing one or more air gaps 72 within the thermal barrier assembly 60. In an embodiment, the integrated features are configured as a roughened surface 74 formed on each inner face 70. The roughened surface 74 establishes a plurality of peaks 76 and valleys 78 on the inner face 70. When the first thermally insulating layer 64 and the second thermally insulating layer 66 are positioned side-by-side and assembled to one another, such as via an adhesive, the peaks 76 and valleys 78 align with one another. The space between the valleys 78 of the first thermally insulating layer 64 and the valleys 78 of the second thermally insulating layer 66 establish the air gaps 72 of the thermal barrier assembly 60.

The air gaps 72 may be configured to increase the thermal resistance of the thermal barrier assembly 60, thereby decreasing cell-to-cell heat transfer across the cell stack 22. The thermal resistance benefits may be achieved while reducing the quantity of material required to form each thermally insulating layer of the thermal barrier assembly 60.

When the thermal management system 50 is configured as a conventional cold plate system, the air gaps 72 may be filled with air to provide low thermal conductivity in a thickness direction of the thermal barrier assembly 60. Alternatively, when the thermal management system 50 is configured as an immersion thermal management system, the air gaps 72 may establish fluid flow channels for circulating the coolant C through an interior volume of the thermal barrier assembly 60.

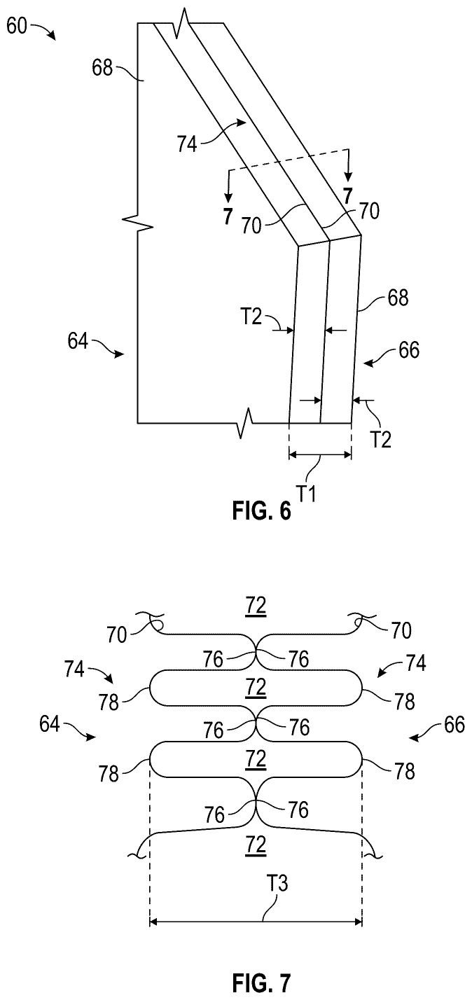

The thermal barrier assembly includes a total thickness T1 (see FIG. 6) that extends in parallel with the length of the cell stack 22 along the cell stack axis A. The total thickness T1 may be between about 2 mm and about 4 mm, for example. However, other thicknesses are contemplated within the scope of this disclosure. In this disclosure, the term “about” means that the expressed quantities or ranges need not be exact but may be approximated and/or larger or smaller, reflecting acceptable tolerances, conversion factors, measurement error, etc.

In an embodiment, the first and second thermally insulating layers 64, 66 may each be made of a mica sheet that includes a thickness T2 that is about ⅓ of the total thickness T1 of the thermal barrier assembly 60. Each air gap 72 may include a third thickness T3 that is also about ⅓ of the total thickness T1 of the thermal barrier assembly 60. However, other thickness ratios for each sublayer of the thermal barrier assembly 60 are contemplated within the scope of this disclosure.

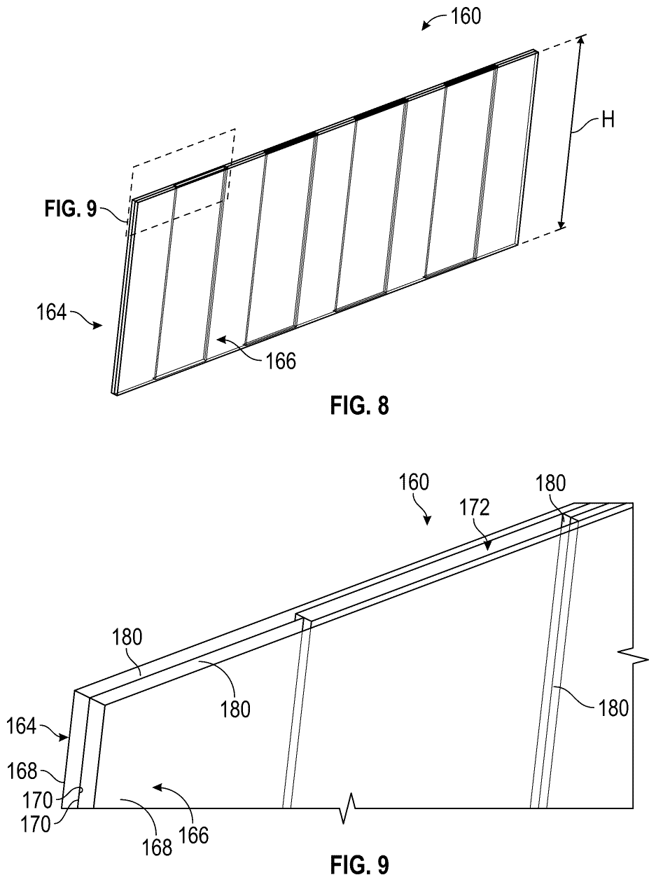

FIGS. 8 and 9 illustrates another exemplary thermal barrier assembly 160 that may function as part of the thermal management system 50 of the traction battery pack 18 described above. The thermal barrier assembly 160 may include a first thermally insulating layer 164 and a second thermally insulating layer 166. The first and second thermally insulating layers 164, 166 may be made of one or more thermally resistant (and thus low thermal conductivity) materials such as mica, aerogel materials, refractory ceramic fibers, etc.

The first thermally insulating layer 164 and the second thermally insulating layer 166 may each include an outer face 168 and an inner face 170 opposite the outer face 168. The outer face 168 may be positioned in direct contact with the first face 34 or the second face 36 of a neighboring battery cell 32 within the cell stack 22, and the inner face 170 may be positioned to interface with the inner face 170 of the other of the first thermally insulating layer 164 or the second thermally insulating layer 166.

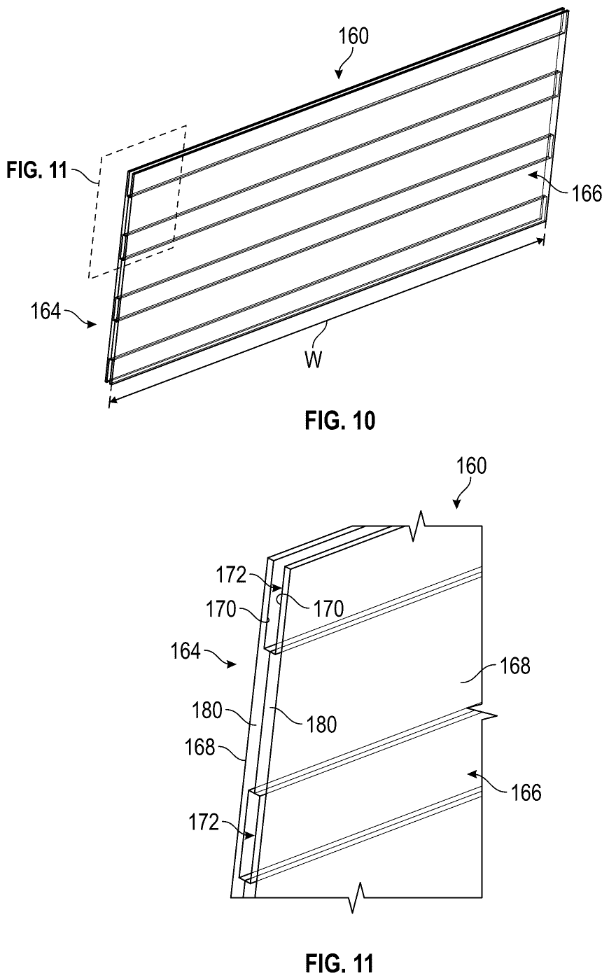

Each inner face 170 may include integrated features that cooperate with integrated features of an adjacent inner face 170 for establishing one or more air gaps 172 within the thermal barrier assembly 60. In an embodiment, the integrated features are configured as raised surfaces 180 that protrude outwardly from the inner face 70. In this embodiment, the raised surfaces 180 extend vertically across a height H of the thermal barrier assembly 160. In another embodiment, the raised surfaces 180 extend horizontally across a width W of the thermal barrier assembly (see, e.g., FIGS. 10 and 11).

When the first thermally insulating layer 164 and the second thermally insulating layer 166 are assembled to one another, such as via an adhesive, the raised surfaces 180 abut one another, and the spaces between adjacent sets of raised surfaces 180 establish the air gaps 172 of the thermal barrier assembly 160.

The air gaps 172 may be configured to increase the thermal resistance of the thermal barrier assembly 160, thereby decreasing cell-to-cell heat transfer across the cell stack 22. The thermal resistance benefits may be achieved while reducing the quantity of material required to form each thermally insulating layer of the thermal barrier assembly 160.

When the thermal management system 50 is configured as a conventional cold plate system, the air gaps 172 may be filled with air to provide low thermal conductivity in a thickness direction of the thermal barrier assembly 160. Alternatively, when the thermal management system 50 is configured as an immersion thermal management system, the air gaps 172 may establish fluid flow channels for circulating the coolant C through an interior volume of the thermal barrier assembly 160.

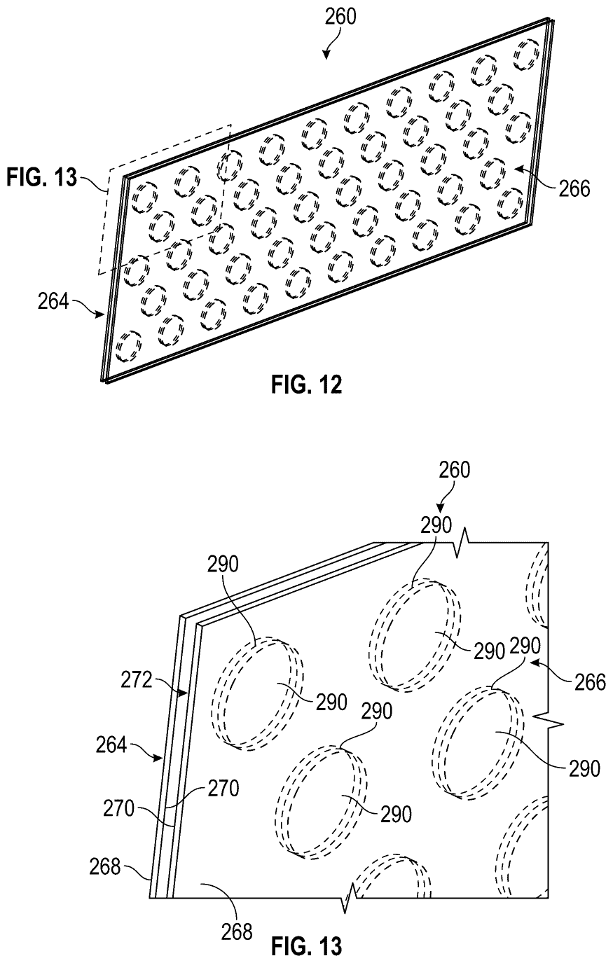

FIGS. 12 and 13 illustrates another exemplary thermal barrier assembly 260 that may function as part of the thermal management system 50 of the traction battery pack 18 described above. The thermal barrier assembly 260 may include a first thermally insulating layer 264 and a second thermally insulating layer 266. The first and second thermally insulating layers 264, 266 may be made of one or more thermally resistant (and thus low thermal conductivity) materials such as mica, aerogel materials, refractory ceramic fibers, etc.

The first thermally insulating layer 264 and the second thermally insulating layer 266 may each include an outer face 268 and an inner face 270 opposite the outer face 268. The outer face 268 may be positioned in direct contact with the first face 34 or the second face 36 of a neighboring battery cell 32 within the cell stack 22, and the inner face 270 may be positioned to interface with the inner face 270 of the other of the first thermally insulating layer 264 or the second thermally insulating layer 266.

Each inner face 270 may include integrated features that cooperate with integrated features of an adjacent inner face 270 for establishing one or more air gaps 272 within the thermal barrier assembly 260. In an embodiment, the integrated features are configured as dimples 290 that protrude outwardly from the inner faces 270. When the first thermally insulating layer 264 and the second thermally insulating layer 266 are positioned side-by-side and assembled to one another, such as via an adhesive, the dimples 290 abut one another, thereby establishing the air gap 272 of the thermal barrier assembly 260.

The air gap 272 may be configured to increase the thermal resistance of the thermal barrier assembly 260, thereby decreasing cell-to-cell heat transfer across the cell stack 22. The thermal resistance benefits may be achieved while reducing the quantity of material required to form each thermally insulating layer of the thermal barrier assembly 260.

When the thermal management system 50 is configured as a conventional cold plate system, the air gap 272 may be filled with air to provide low thermal conductivity in a thickness direction of the thermal barrier assembly 260. Alternatively, when the thermal management system 50 is configured as an immersion thermal management system, the air gap 272 may establish fluid flow channels for circulating the coolant C through an interior of the thermal barrier assembly 260.

The exemplary thermal barrier assemblies of this disclosure are configured to provide increased thermal resistance while requiring less thermally resistance material in the same amount of packaging space. The proposed thermal barrier designs can be used for both immersion cooling and non-immersion cooling thermal arrangements, thereby providing increased utility compared to prior barrier systems.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
a cell stack including a first battery cell, a second battery cell, and a thermal barrier assembly arranged to limit heat transfer between the first battery cell and the second battery cell,
wherein the thermal barrier assembly includes a first thermally insulating layer, a second thermally insulating layer, and an air gap.

2. The traction battery pack as recited in claim 1, wherein the cell stack includes a cell expansion pad arranged between the first battery cell and a third battery cell.

3. The traction battery pack as recited in claim 1, wherein an inner face of each of the first thermally insulating layer and the second thermally insulating layer includes a roughened surface having a plurality of peaks and a plurality of valleys.

4. The traction battery pack as recited in claim 3, wherein the air gap extends between a first valley of the plurality of valleys of the first thermally insulating layer and a second valley of the plurality of valleys of the second thermally insulating layer.

5. The traction battery pack as recited in claim 1, wherein an inner face of each of the first thermally insulating layer and the second thermally insulating layer includes a raised surface.

6. The traction battery pack as recited in claim 5, wherein the raised surface extends vertically across a height of the thermal barrier assembly.

7. The traction battery pack as recited in claim 5, wherein the raised surface extends horizontally across a width W of the thermal barrier assembly.

8. The traction battery pack as recited in claim 5, wherein the air gap extends between adjacent sets of raised surfaces provided by the inner face of each of the first thermally insulating layer and the second thermally insulating layer.

9. The traction battery pack as recited in claim 1, wherein an inner face of each of the first thermally insulating layer and the second thermally insulating layer includes a dimple.

10. The traction battery pack as recited in claim 9, wherein the dimple of the first thermally insulating layer abuts the dimple of the second thermally insulating layer to establish the air gap.

11. The traction battery pack as recited in claim 1, wherein the cell stack includes a third battery cell, a fourth battery cell, and a second thermal barrier assembly arranged to limit heat transfer between the third battery cell and the fourth battery cell.

12. The traction battery pack as recited in claim 1, wherein the air gap establishes a fluid flow channel through an interior volume of the thermal barrier assembly.

13. The traction battery pack as recited in claim 1, wherein the thermal barrier assembly includes a first thickness, and the first thermally insulating layer includes a second thickness that is about ⅓ of the first thickness.

14. The traction battery pack as recited in claim 1, wherein the thermal barrier assembly includes a first thickness, and the air gap includes a second thickness that is about ⅓ of the first thickness.

15. The traction battery pack as recited in claim 1, wherein each of the first thermally insulating layer and the second thermally insulating layer is a mica sheet.

16. A traction battery pack, comprising:
a first battery cell;
a second battery cell; and
a thermal barrier assembly arranged between the first battery cell and the second battery cell, the thermal barrier assembly including a first thermally insulating layer having a first integrated feature and a second thermally insulating layer having a second integrated feature,
wherein the first integrated feature and the second integrated feature cooperate to establish an air gap between the first thermally insulating layer and the second thermally insulating layer.

17. The traction battery pack as recited in claim 16, wherein the first integrated feature and the second integrated feature include roughened surfaces.

18. The traction battery pack as recited in claim 16, wherein the first integrated feature and the second integrated feature include raised surfaces.

19. The traction battery pack as recited in claim 16, wherein the first integrated feature and the second integrated feature include dimples.

20. The traction battery pack as recited in claim 16, the first thermally insulating layer includes a first outer face that is received in abutting contact with the first battery cell and a first inner face that provides the first integrated feature, and the second thermally insulating layer includes a second outer face that is received in abutting contact with the second battery cell and a second inner face that provides the second integrated feature.
